(19) United States
(12) Patent Application Publication
(10) Pub. No.: US 2026/0158986 A1
(43) Pub. Date: Jun. 11, 2026

(54) MOVABLE A-FRAME

(71) Applicant: Thor Tech. Inc., Elkhart, IN (US)

(72) Inventors: Raymond McKay Featherstone, Tipp City, OH (US); Anthony Slocock, Northleach (GB)

(73) Assignee: Thor Tech. Inc., Elkhart, IN (US)

(21) Appl. No.: 19/356,415

(22) Filed: Oct. 13, 2025

Related U.S. Application Data
(60) Provisional application No. 63/706,344, filed on Oct. 11, 2024.

(51) Int. Cl. B60P 3/32

(52) U.S. Cl. CPC B60P 3/32

(57) ABSTRACT

A recreational vehicle (RV) may include a chassis that may include a pair longitudinal frame rails, an RV body enclosing a living area supported by the chassis, and a movable A-frame. The movable A-frame may include a towing point configured to be coupled to a towing hitch of a towing vehicle and a tongue that may include a first arm and a second extending from the towing point to an A-frame coupling of each of the longitudinal frame rails. The tongue may be movably coupled to the A-frame coupling of the longitudinal frame rails and the movable A-frame may translate along A-frame couplings of the longitudinal frame rails between a retracted position and an extended position, and a towing distance between the front cross-member of the chassis and the towing point of the movable A-frame may be greater in the extended position than the retracted position.

### CROSS-REFERENCE TO RELATED APPLICATIONS

This application claims the benefit of U.S. Provisional Application Ser. No. 63/706,344, filed Oct. 11, 2024.

### BACKGROUND

The present disclosure relates to recreational vehicles. Specifically, the present disclosure relates to A-frames of recreational vehicles.

### BRIEF SUMMARY

According to the subject matter of the present disclosure, a recreational vehicle (RV) is provided. Contemplated RVs include a chassis with a pair of longitudinal rails and a movable A-frame movably coupled to the longitudinal rails of the chassis. The movable A-frame provides for increased fuel efficiency at high speeds, while also providing maneuverability at low-speeds. The movable A-frame also provides structural integrity to the chassis and connection of the chassis to the towing vehicle.

Traditionally, RVs are connected to a towing vehicle through a fixed towing point. An A-frame may extend from the chassis of the RV to connect to the towing vehicle. A distance between the towing vehicle and RV is typically fixed. Such a distance must be large enough such that the RV does not impact a rear of the towing vehicle when the towing vehicle conducts sharp turns at low speeds. However, such a large distance between the towing vehicle and the RV results in poor fuel efficiency, especially when the RV is being towed at high speeds, due to decreased aerodynamics (e.g., air leaving the rear of the towing vehicle is caught between the towing vehicle and the RV). Moreover, RVs that include telescopic drawbars or A-frames suffer from poor mechanical quality, as such telescopic features are likely to break due to large forces acting on the drawbar/A-frame. Thus, embodiments described herein provide for an RV with a movable A-frame coupled to longitudinal frame rails of the chassis of the RV. Such a movable A-frame provides for mechanical durability, increased aerodynamics resulting in increased fuel efficiency, and proper clearance between the towing vehicle and RV such that the towing vehicle does not interfere with RV maneuverability.

The present disclosure is directed to a movable A-frame that can adaptively adjust the towing distance between the towing vehicle and the RV to decrease the towing distance and, thus, maximize aerodynamic performance at high speeds, while increasing the towing distance at lower speeds such that a turning radius of the towing vehicle is not restricted.

In accordance with one embodiment of the present disclosure, a recreational vehicle (RV) may include a chassis that may include a pair longitudinal frame rails laterally spaced from one another, each longitudinal frame rail may include a front end, a rear end, an A-frame coupling extending along a portion of the longitudinal frame rail, and a front cross-member connecting the front ends of the pair of laterally spaced longitudinal frame rails. The RV may further include an RV body enclosing a living area supported by the chassis and a movable A-frame. The movable A-frame may include a towing point configured to be coupled to a towing hitch of a towing vehicle, a tongue that may include a first arm extending from the towing point to the A-frame coupling of a first one of the longitudinal frame rails, and a second arm extending from the towing point to the A-frame coupling of a second one of the longitudinal frame rails. The tongue may be movably coupled to the A-frame coupling of the longitudinal frame rails, the movable A-frame may translate along the A-frame couplings of the longitudinal frame rails between a retracted position and an extended position, and a towing distance between the front cross-member of the chassis and the towing point of the movable A-frame may be greater in the extended position than the retracted position. The RV may also include an A-frame actuator to translate the movable A-frame between the retracted position and the extended position.

In accordance with another embodiment of the present disclosure, an RV may include a chassis that may include a pair longitudinal frame rails laterally spaced from one another, each longitudinal frame rail may include a front end, a rear end, an A-frame coupling extending along a portion of the longitudinal frame rail, and a front cross-member at the front end of the longitudinal frame rails. The RV may also include an RV body enclosing a living area supported by the chassis and a movable A-frame connected to the A-frame coupling of the longitudinal frame rails. The A-frame coupling of each longitudinal frame rail may include an A-frame connection slot and the movable A-frame may be connected to the A-frame connection slots of the longitudinal frame rails through a rack and pinion. The movable A-frame may include a towing point configured to be coupled to a towing hitch of a towing vehicle and a tongue that may include a first arm extending from the towing point to the A-frame coupling of a first one of the longitudinal frame rails, and a second arm extending from the towing point to the A-frame coupling of a second one of the longitudinal frame rails. The RV may also include an A-frame positioning system that may include an A-frame actuator, at least one processor, at least one non-transitory memory module communicatively coupled to the at least one processor and storing machine readable instructions that, when executed by the at least one processor, may cause the at least one processor to translate the movable A-frame along the A-frame coupling of the longitudinal frame rails to a retracted position when the RV is traveling above a threshold speed using the A-frame actuator and translate the movable A-frame along the A-frame coupling of the longitudinal frame rails to an extended position when the RV is traveling below the threshold speed. A towing distance may be greater in the extended position than the retracted position using the A-frame actuator.

In accordance with another embodiment of the present disclosure, an RV may include a chassis that may include a pair longitudinal frame rails laterally spaced from one another, each longitudinal frame rail may include a front end, a rear end, an A-frame coupling extending along a portion of the longitudinal frame rails, and a front cross-member connecting the front ends of the pair of laterally spaced longitudinal frame rails. The RV may also include an RV body enclosing a living area supported by the chassis and a movable A-frame. The movable A-frame may include a towing point configured to be coupled to a towing hitch of a towing vehicle and a tongue that may include a first arm extending from the towing point to the A-frame coupling of a first one of the longitudinal frame rails, and a second arm extending from the towing point to the A-frame coupling of a second one of the longitudinal frame rails. The movable A-frame may translate along the A-frame coupling of the longitudinal frame rails between a retracted position and an extended position.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 depicts a recreational vehicle (RV), according to one embodiment of the present disclosure;

FIG. 2 depicts a bottom view of a chassis of an RV, according to one embodiment of the present disclosure;

FIG. 3 depicts an isometric view of a chassis of an RV, according to one embodiment of the present disclosure;

FIG. 4A depicts an RV in a retracted position, according to one embodiment of the present disclosure;

FIG. 4B depicts an RV in an extended position, according to one embodiment of the present disclosure;

FIG. 5A depicts a bottom view of a chassis of an RV in a retracted position, according to one embodiment of the present disclosure;

FIG. 5B depicts a bottom view of a chassis of an RV in an extended position; and

FIG. 6 depicts an A-frame positioning system.

### DETAILED DESCRIPTION

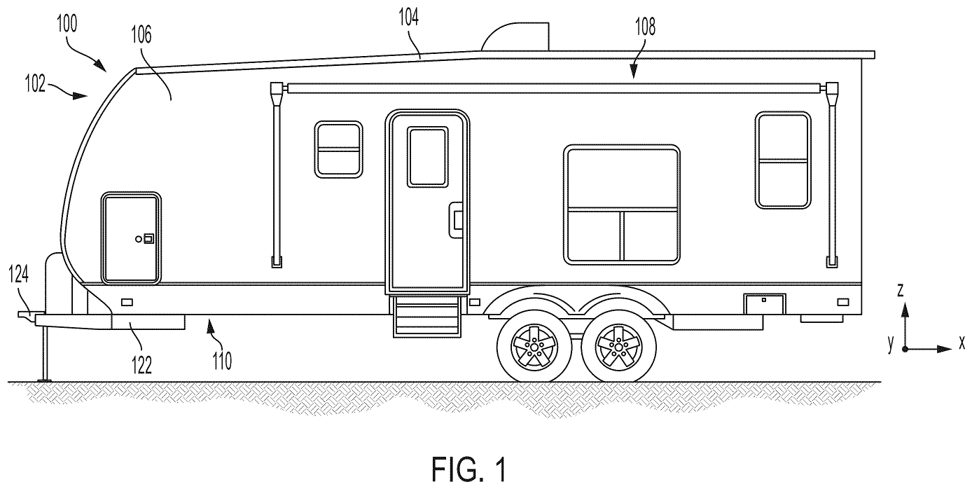

FIG. 1 depicts an RV 100 with an RV body 102. The RV body 102 includes an RV roof 104 and RV walls 106. The RV body 102 encloses a living area 108 where passengers reside. The RV body 102 is supported by a chassis 110.

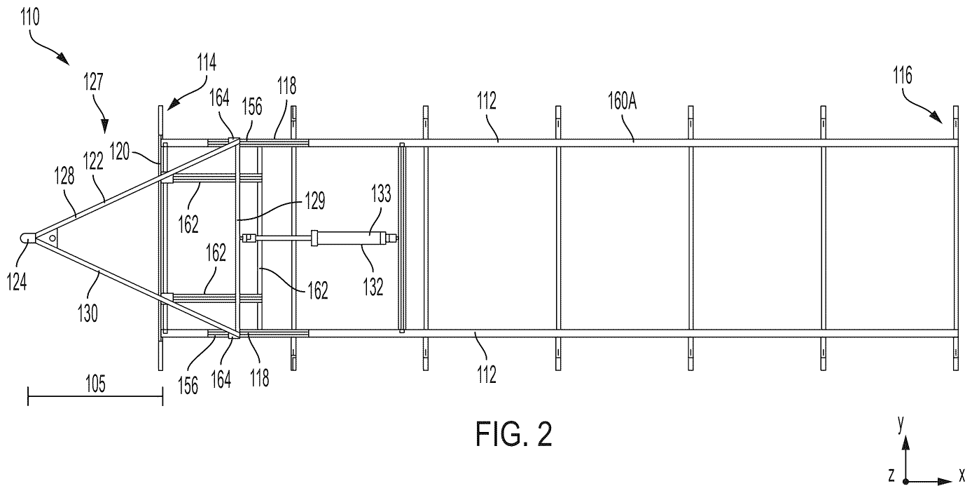

Referring now to FIG. 2, the chassis 110 includes a pair of longitudinal frame rails 112 that each include a front end 114, a rear end 116, and an A-frame coupling 118 extending along a portion of the longitudinal frame rails 112. Generally, the A-frame coupling 118 may be near the front end 114 of the longitudinal frame rails 112. The RV 100 also includes a front cross-member 120 connecting the front ends 114 of the pair of laterally spaced longitudinal frame rails 112. The RV 100 further includes a movable A-frame 122. The movable A-frame 122 includes a towing point 124 configured to be coupled to a towing hitch of a towing vehicle. The movable A-frame 122 also includes a tongue 127 that includes a first arm 128 extending from the towing point 124 to the A-frame coupling 118 of a first one of the longitudinal frame rails 112, and a second arm 130 extending from the towing point 124 to the A-frame coupling 118 of a second one of the longitudinal frame rails 112.

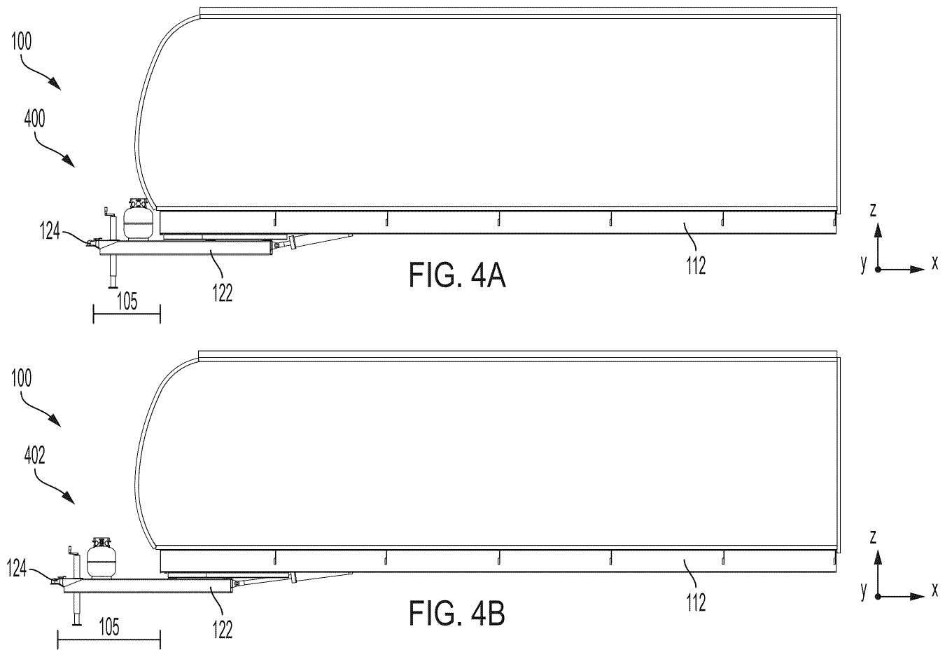

The movable A-frame 122 is movably coupled to the A-frame coupling 118 of the longitudinal frame rails 112, such that the movable A-frame 122 translates along the A-frame couplings of the longitudinal frame rails 112 between a retracted position 400 (as depicted in FIG. 4A), and an extended position 402 (as depicted in FIG. 4B). As depicted in FIGS. 4A and 4B, a towing distance 105 between the front cross-member 120 of the chassis 110 and the towing point 124 of the movable A-frame 122 is greater in the extended position 402 than the retracted position 400. An A-frame actuator 132 translates the movable A-frame 122 between the retracted position 400 and the extended position 402.

The movable A-frame 122 may be positioned in the retracted position 400 when the RV 100 is traveling at high speeds (e.g., above 35 mph) and, as such, may increase fuel efficiency of the towing vehicle due to increased aerodynamics when the movable A-frame 122 is in the retracted position 400. Such increased aerodynamics may result from less wind resistance on the front end of the RV 100. In contrast, the movable A-frame 122 may be positioned in the extended position 402 when the RV 100 is traveling at low speeds (e.g., below 35 mph) and, as such, may increase clearance between the front end of the RV 100 and the rear end of the towing vehicle. Such increased clearance may be needed at low speeds due to sharper turns occurring at low speeds. Moreover, aerodynamics are less important to fuel efficiency when the RV 100 is traveling at low speeds. Movement of the movable A-frame 122 between the retracted position 400 and the extended position 402 are discussed further below.

The chassis 110 may further include a plurality of cross members 140 extending across the chassis 110 perpendicular to the pair of longitudinal frame rails 112. The cross members 140 may be evenly spaced across the length of the chassis 110 or the cross members 140 may be irregularly spaced across the length of the chassis 110. The chassis 110 and movable A-frame 122 may be constructed from any suitable metal, metal alloy, or other suitable material to maintain the structural integrity of the chassis 110 during its operation.

The chassis 110 may also include one or more axles 152 extending across a width of the chassis 110 (i.e., in the y-direction of the Cartesian Coordinates of FIG. 2). As depicted in FIG. 2, the chassis 110 may include two axles 152 positioned proximate to one another along the length of the chassis 110. Tires are mounted to the ends of each of the axles 152 to be positioned near the perimeter of the chassis 110. In embodiments, one or more of the axles 152 may be motorized. For example, a motor (not depicted) may be rotatably coupled to one or more of the axles 152, which may provide thrust/braking forces to the chassis 110. The motor may be powered by a battery coupled to the chassis 110, a motor of the RV 100, or a battery coupled to the towing vehicle.

In embodiments, the geometry of the movable A-frame 122 is static such that the movable A-frame 122 moves in relation to the chassis 110; the movable A-frame 122 itself does not itself change length/dimensions. In other words, the first arm 128 and the second arm 130 may define a constant angle θ at the towing point 124. This has the added advantage of maximizing the mechanical integrity of the movable A-frame 122 by reducing the amount of moving components (e.g., components of the movable A-frame 122 itself are not moving, but the entirety of the movable A-frame 122 is moved along the longitudinal frame rails 112). The towing distance 105 between the front cross member 120 of the chassis 110 and the towing point 124 of the movable A-frame 122 may be varied by moving the movable A-frame within the A-frame coupling 118 of the longitudinal frame rails 112.

As noted hereinabove, the movable A-frame 122 may be connected to the longitudinal frame rails 112 of the chassis 110 through the A-frame coupling 118. In embodiments, the A-frame coupling 118 of each of the longitudinal frame rails 112 may include an A-frame connection slot 156, such that the movable A-frame 122 may be connected to the A-frame connection slots 156 of the longitudinal frame rails 112. The movable A-frame 122 may be connected to the A-frame connection slots 156 of the longitudinal frame rails 112 through a rack and pinion. Specifically, the A-frame connection slots 156 may include the toothed rack that connects/interacts with a pinion of the movable A-frame 122. Moreover, the movable A-frame 122 may be connected to the A-frame connection slots 156 of the longitudinal frame rails 112 through a roller track. Specifically, the A-frame connection slots 156 may include the roller track that connects/interacts with a roller of the movable A-frame 122. It should be understood that the movable A-frame 122 may be connected to the A-frame coupling of the longitudinal frame rails 112 through any suitable coupling that allows the movable A-frame 122 to translate along the longitudinal frame rails 112.

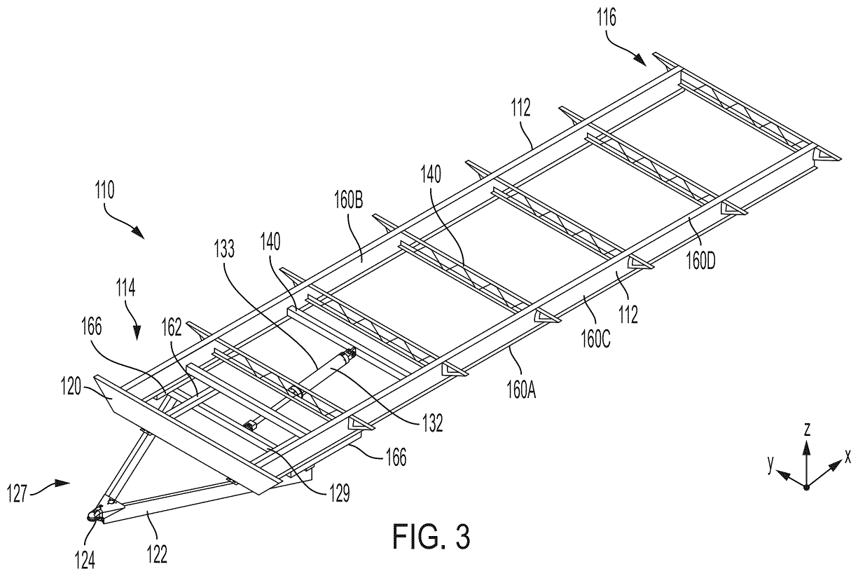

The movable A-frame 122 may be connected to any portion of the longitudinal frame rails 112. As depicted in FIG. 3, the movable A-frame 122 may be positioned on an underside 160A of the longitudinal frame rails 112. Such an embodiment allows for the movable A-frame 122 and A-frame coupling 118 to be hidden from/not interact with cross-members of the chassis 110. In embodiments, the A-frame coupling 118 may also be positioned on an interior side 160B, an exterior side 160C, or a top side 160D of the longitudinal frame rails 112. In embodiments, the A-frame coupling 118 (and, thus, the connection of the longitudinal frame rails 112 to the movable A-frame 122) may be positioned based on a connection of other components to the longitudinal frame rails. For example, if tanks, flooring, or other components are mounted on the interior side 160B, exterior side 160C, and top side 160D of the longitudinal frame rails 112, then the A-frame coupling 118 may be positioned on the underside 160A of the longitudinal frame rails 112.

In embodiments, the longitudinal frame rails 112 may include longitudinal rails plates 166. The longitudinal rail plates 166 may be connected to the longitudinal frame rails 112 and may include the A-frame coupling 118. The longitudinal rail plates 166 may add stability/structural integrity to the longitudinal frame rails 112, the movable A-frame 122, and the connection between the longitudinal frame rails 112 and the movable A-frame 122. The longitudinal rails plates 166 may be on any portion of the longitudinal frame rails 112, such as the underside 160A, interior side 160B, exterior side 160C, or top side 160D of the longitudinal frame rails 112.

As depicted in FIGS. 2-3, the chassis 110 may further include additional supports 162 near the front end 114 of the chassis 110 to support the movable A-frame 122. Moreover, the additional supports 162 may also include the A-frame coupling 118 to support the movable A-frame 122 as the movable A-frame is moved between the retracted position 400 and the extended position 402. The supports 162, may be positioned below, above, or beside the movable A-frame 122 to support the movable A-frame 122.

supports 162 may be positioned above the movable A-frame 122, while the

Referring still to FIGS. 2-3, the movable A-frame 122 may be translated between the retracted position 400 and the extended position 402 utilizing the A-frame actuator 132. In embodiments, the A-frame actuator 132 may include a hydraulic cylinder 133 to translate the movable A-frame 122. The hydraulic cylinder 133 may be connected to a cross-member 140 of the chassis 110. The cross-member 140 may be an existing cross-member of the chassis 110, or an additional cross-member 140 may be added to the chassis 110 to accommodate the hydraulic cylinder 133/actuator 132. The hydraulic cylinder 133 may also be coupled to a tongue cross-member 129 of the movable A-frame 122, such that the hydraulic cylinder 133 may translate the movable A-frame 122. Controlling of the A-frame actuator 132 and translation of the movable A-frame 122 between the retracted position 400 and the extended position 402 utilizing an A-frame positioning system 200 are discussed further below.

The A-frame actuator 132 may include an electric motor to translate the movable A-frame 122 between the retracted position 400 and the extended position 402. The electric motor may be powered by/electrically coupled to a battery of the RV 100. The electric motor may also be powered by/electrically coupled to a battery of the towing vehicle. In embodiments, the A-frame actuator 132 may include the hydraulic cylinder 133, the electric motor, a combination thereof, or any other suitable actuator for translating the movable A-frame 122 between the retracted position 400 and the extended position 402.

Once the movable A-frame 122 is translated to the retracted position 400 or the extended position 402 (or anywhere there-between, as discussed further below), the movable A-frame may be locked into place through the use of a locking mechanism 164. The locking mechanism 164 may be connected to the movable A-frame 122 and the A-frame coupling 118 of the longitudinal frame rails 112 to lock the movable A-frame 122 into place. The locking mechanism 164 may be a tab, a pin, a latch, locking gear, or any other suitable locking mechanism. Moreover, the locking mechanism 164 may be spring-loaded. The locking mechanism 164 may be on one side or both sides of the movable A-frame 122.

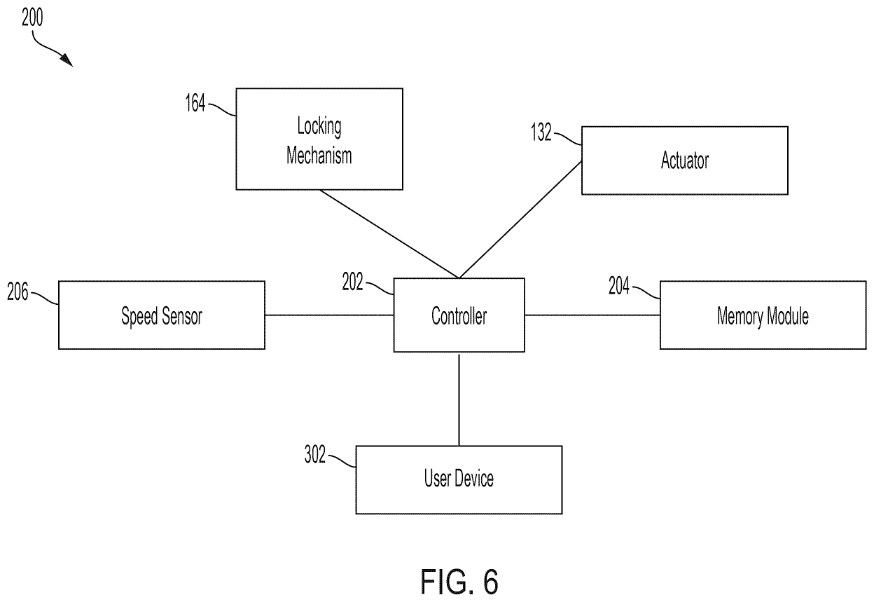

Referring now to FIG. 6, as noted hereinabove, the RV 100 may also include an A-frame positioning system 200. The A-frame positioning system may include at least one processor 202 and at least one non-transitory memory module 204 communicatively coupled to the processor 202. The memory module 204 may store machine readable instructions that, when executed by the processor 202, cause the processor 202 (e.g., the A-frame positioning system 200) to perform various functions. In embodiments, the A-frame positioning system 200 may translate the movable A-frame 122 along the A-frame coupling 118 of the longitudinal frame rails 112 to the retracted position 400 when the RV 100 is traveling above a threshold speed, and translate the movable A-frame 122 along the A-frame coupling 118 of the longitudinal frame rails 112 to the extended position 402 when the RV 100 is traveling below the threshold speed. The threshold speed may be between 30 mph and 50 mph, or between 35 mph and 45 mph.

A speed of the RV 100 may be determined through an RV speed sensor 206 in communication with the a-frame positioning system 200. The RV speed sensor 206 may be positioned within an axle of the RV 100. The A-frame positioning system 200 may also be communicatively coupled to the towing vehicle. As such, the A-frame positioning system 200 may determine the RV speed through the speed of the towing vehicle (since the speed of the towing vehicle and the RV 100 are the same). In embodiments, the RV positioning system 200 may also be communicatively coupled to a user device 302, such that the user may set the movable A-frame 122 position (e.g., to the retracted position 400 or the extended position 402).

The movable A-frame 122 is positioned in the extended position 402 when the RV 100 is traveling below the threshold speed for increased clearance between the towing vehicle and the RV 100, while the movable A-frame 122 is positioned in the retracted position 400 when the RV 100 is traveling above the threshold speed for increased aerodynamics and, thus, increased fuel efficiency.

The movable A-frame 122 may be in the retracted position 400 when the RV 100 is traveling at high speeds (e.g.. when the RV 100 is traveling above the threshold speed). The movable A-frame 122 in the retracted position 400 provides for a lessened towing distance 105 and, thus, less space between the towing vehicle and the RV 100. The movable A-frame 122 being in the retracted position 400 may provide for better aerodynamics while the towing vehicle and RV 100 are traveling. As such, the retracted position 400 provides for better fuel efficiency. Moreover, the turns the towing vehicle makes at high speeds are much wider than turns the towing vehicle may make at low speeds. As such, there is less need for space between the towing vehicle and the RV 100 at high speeds, as the rear of the towing vehicle will not bump the front of the RV 100 because the towing vehicle is highly unlikely to execute sharp turns at high speeds. The towing distance 105 in the retracted position 400 may be from 20 inches (51 centimeters) to 30 inches (76 centimeters), or any other suitable distance. Moreover, a distance between the front end of the RV 100 and the rear end of the towing vehicle may be from 20 inches (51 centimeters) to 28 inches (20 centimeters) in the retracted position 400. The towing distance 105 in the retracted position 400 may be dependent on the dimensions of the front of the RV 100 and the rear of the towing vehicle. As such, it is noted that the distance between the front end of the RV 100 and the rear of the towing vehicle, and the towing distance, may vary from the aforementioned distances depending on the geometry of the RV 100 and/or towing vehicle. As dimensions vary across makes/models, the towing distance 105 may also need to change. A larger front end of the RV 100 and/or a larger rear end of the towing vehicle may increase the required towing distance 105.

The movable A-frame 122 may be in the extended position 402 when the RV 100 is traveling at low speeds (e.g., when the RV 100 is traveling below the threshold speed). The movable A-frame 122 in the extended position 402 provides for an increased towing distance 105 and, thus, more space between the towing vehicle and the RV 100. The movable A-frame being in the extended position 402 may decrease aerodynamics when compared to aerodynamics in the retracted position 400. However, aerodynamics are much less important to fuel efficiency at low speeds. Moreover, the turns the towing vehicle makes at low speeds are much sharper than turns the towing vehicle may make at high speeds. As such, there is an increased need for space between the towing vehicle and the RV 100 at low speeds, as the rear of the towing vehicle needs more clearance not to bump the front of the RV 100 when the towing vehicle is executing sharp turns at low speeds. The towing distance 105 in the extended position 402 may be from 40 inches (101 centimeters) to 60 inches (152 centimeters), or any other suitable distance. Moreover, a distance between the front end of the RV 100 and the rear end of the towing vehicle may be from 35 inches (89 centimeters) to 55 inches (140 centimeters) in the extended position 402. The towing distance 105 in the extended position 402 may be dependent on the dimensions of the front of the RV 100 and the rear of the towing vehicle. As such, it is noted that the distance between the front end of the RV 100 and the rear of the towing vehicle, and the towing distance, may vary from the aforementioned distances depending on the geometry of the RV 100 and/or towing vehicle. Moreover, a distance between the retracted position 400 and the extended position 402 may be between 20 inches (51 centimeters) and 60 inches (152 centimeters).

As dimensions vary across makes/models, the towing distance 105 may also need to change. A larger front end of the RV 100 and/or a larger rear end of the towing vehicle may increase the required towing distance 105.

In embodiments, a location of the movable A-frame 122 within the A-frame coupling 118 may be variable depending on the speed of the RV 100. For example, the movable A-frame 122 may translate along a continuum of points between the retracted position 400 and the extended position 402 based on the speed of the RV 100. As such, the movable A-frame 122 may continually translate within the A-frame coupling 118 when the RV 100 changes speeds and, thus, continually vary the towing distance 105. Moreover, the retracted position 400 and the extended position 402 may act as limits as to the towing distance 105/positions of the movable A-frame 122 within the A-frame coupling 118. As such, there may be a retracted threshold speed and an extended threshold speed. The retracted threshold speed may be near 60 mph and the extended threshold speed may be near 30 mph. The movable A-frame 122 may be in the retracted position 400 when the RV 100 is traveling at the retracted threshold speed, while the movable A-frame 122 may be in the extended position 402 when the RV 100 is traveling at the extended threshold speed. In embodiments, the position of the movable A-frame 122 within the A-frame coupling 118 when the RV 100 is traveling at a speed between the retracted threshold speed and the extended threshold speed is continually varied (e.g., the movable A-frame moves toward the retracted position 400 as speeds increase, and toward the extended position 402 as speeds decrease), such that the towing distance 105 is continually varied. Moreover, there may be any number of threshold speed between the retracted threshold speed and the extended threshold speed, such that the movable A-frame 122 is moved to a different position at each threshold speed.

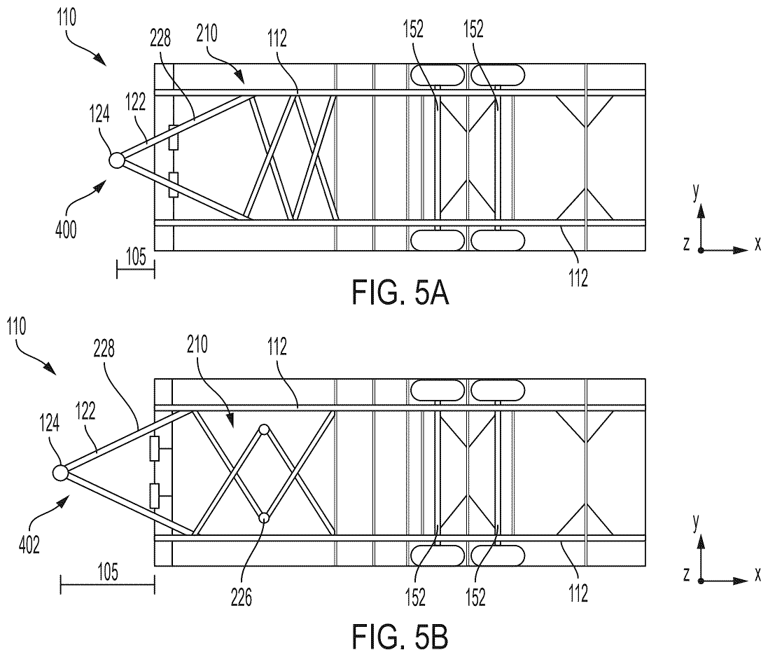

Referring now to FIGS. 5A and 5B, the movable A-frame 122 may further include a scissor mechanism 210. The scissor mechanism 210 may function to selectively adjust the towing distance 105 by moving the movable A-frame 122 between the retracted position 400 and the extended position 402, as depicted in FIGS. 5A and 5B, respectively. In embodiments,

In embodiments, the scissor mechanism 210 includes a plurality of linking pieces 228 each coupled to a hinge 226. Moreover, each linking piece 228 may be coupled to the A-frame coupling 118 of the longitudinal frame rails 112. The scissor mechanism 210 may translate the movable A-frame 122 between the retracted position 400 and the extended position 402, or anywhere therebetween, as discussed hereinabove.

Collectively, the various features of the RV, movable A-frame, and A-frame positioning system described herein provide for more increased aerodynamics and, thus, increased fuel efficiency without sacrificing clearance between the RV and towing vehicle. Notably, the movable A-frame is positioned further away from the towing vehicle when the RV is traveling at low speeds, while the movable A-frame is positioned closer to the towing vehicle when the RV is traveling at high speeds. The movable A-frame may also be continually adjustable, such that the movable A-frame is positioned between a retracted position and an extended position based on a speed of the RV. Moreover, the movable A-frame translating along the chassis of the RV, rather than the A-frame itself varying in length, provides structural integrity to the RV and the connection of the RV to the towing vehicle.

For the purposes of describing and defining the present invention it is noted that terms like “near” are utilized herein to represent the inherent degree of uncertainty that may be attributed to any quantitative comparison, value, measurement, or other representation. The term “near” is also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. A recreational vehicle (RV) comprising:
a chassis comprising:
a pair longitudinal frame rails laterally spaced from one another, each comprising:
a front end;
a rear end;
an A-frame coupling extending along a portion of the longitudinal frame rail; and
a front cross-member connecting the front ends of the pair of laterally spaced longitudinal frame rails;
an RV body enclosing a living area supported by the chassis;
a movable A-frame comprising:
a towing point configured to be coupled to a towing hitch of a towing vehicle;
a tongue comprising a first arm extending from the towing point to the A-frame coupling of a first one of the longitudinal frame rails, and a second arm extending from the towing point to the A-frame coupling of a second one of the longitudinal frame rails, wherein:
the tongue is movably coupled to the A-frame coupling of the longitudinal frame rails;
the movable A-frame translates along the A-frame couplings of the longitudinal frame rails between a retracted position and an extended position; and
a towing distance between the front cross-member of the chassis and the towing point of the movable A-frame is greater in the extended position than the retracted position; and
an A-frame actuator to translate the movable A-frame between the retracted position and the extended position.

2. The RV of claim 1, further comprising:
an A-frame positioning system comprising:
at least one processor; and
at least one non-transitory memory module communicatively coupled to the at least one processor and storing machine readable instructions that, when executed by the at least one processor, cause the at least one processor to perform at least the following:
translate the movable A-frame along the A-frame coupling of the longitudinal frame rails to the retracted position when the RV is traveling above a threshold speed; and
translate the movable A-frame along the A-frame coupling of the longitudinal frame rails to the extended position when the RV is traveling below the threshold speed.

3. The RV of claim 2, further comprising an RV speed sensor in communication with the A-frame positioning system.

4. The RV of claim 2, wherein the threshold speed is between 35 mph and 45 mph.

5. The RV of claim 1, wherein the A-frame coupling of each longitudinal frame rail comprises an A-frame connection slot and the movable A-frame is connected to the A-frame connection slots of the longitudinal frame rails through a rack and pinion.

6. The RV of claim 1, wherein the A-frame coupling of each longitudinal frame rail comprises an A-frame connection slot and the movable A-frame is connected to the A-frame connection slots of the longitudinal frame rails through a roller track.

7. The RV of claim 1, wherein the A-frame coupling is positioned on an underside or an interior side of the longitudinal frame rails.

8. The RV of claim 1, further comprising a longitudinal rail plate coupled to the longitudinal frame rails, wherein the longitudinal rail plate comprises the movable A-frame coupling.

9. The RV of claim 1, wherein the A-frame actuator comprises a hydraulic cylinder to translate the movable A-frame between the retracted position and the extended position.

10. The RV of claim 9, wherein the hydraulic cylinder is coupled to a tongue cross member of the movable A-frame.

11. The RV of claim 1, wherein the A-frame actuator comprises an electric motor to translate the movable A-frame between the retracted position and the extended position.

12. The RV of claim 1, further comprising a locking mechanism, wherein the locking mechanism locks the movable A-frame into the retracted position or the extended position.

13. The RV of claim 1, wherein the movable A-frame translates along the A-frame coupling of the longitudinal frame rails along a continuum of points between the retracted position and the extended position based on a speed of the RV.

14. The RV of claim 1, wherein a distance between the retracted position and the extended position is between 20 inches (51 centimeters) and 60 inches (152 centimeters).

15. A recreational vehicle (RV) comprising:
a chassis comprising:
a pair longitudinal frame rails laterally spaced from one another, each comprising:
a front end;
a rear end;
an A-frame coupling extending along a portion of the longitudinal frame rail; and
a front cross-member at the front end of the longitudinal frame rails;
an RV body enclosing a living area supported by the chassis;
a movable A-frame connected to the A-frame coupling of the longitudinal frame rails, wherein the A-frame coupling of each longitudinal frame rail comprises an A-frame connection slot and the movable A-frame is connected to the A-frame connection slots of the longitudinal frame rails through a rack and pinion, the movable A-frame comprising:
a towing point configured to be coupled to a towing hitch of a towing vehicle; and
a tongue comprising a first arm extending from the towing point to the A-frame coupling of a first one of the longitudinal frame rails, and a second arm extending from the towing point to the A-frame coupling of a second one of the longitudinal frame rails; and
an A-frame positioning system comprising:
an A-frame actuator;
at least one processor;
at least one non-transitory memory module communicatively coupled to the at least one processor and storing machine readable instructions that, when executed by the at least one processor, cause the at least one processor to perform at least the following:
translate the movable A-frame along the A-frame coupling of the longitudinal frame rails to a retracted position when the RV is traveling above a threshold speed using the A-frame actuator; and
translate the movable A-frame along the A-frame coupling of the longitudinal frame rails to an extended position when the RV is traveling below the threshold speed, wherein a towing distance is greater in the extended position than the retracted position using the A-frame actuator.

16. The RV of claim 15, wherein the A-frame actuator comprises a hydraulic cylinder to translate the movable A-frame between the retracted position and the extended position.

17. The RV of claim 16, wherein the hydraulic cylinder is coupled to a tongue cross member of the movable A-frame.

18. The RV of claim 15, wherein the A-frame actuator comprises an electric motor to translate the movable A-frame between the retracted position and the extended position.

19. The RV of claim 15, wherein the movable A-frame translates along the A-frame coupling of the longitudinal frame rails along a continuum of points between the retracted position and the extended position based on a speed of the RV.

20. A recreational vehicle (RV) comprising:
a chassis comprising:
a pair longitudinal frame rails laterally spaced from one another, each comprising:
a front end;
a rear end;
an A-frame coupling extending along a portion of the longitudinal frame rails; and
a front cross-member connecting the front ends of the pair of laterally spaced longitudinal frame rails;
an RV body enclosing a living area supported by the chassis;
a movable A-frame comprising:
a towing point configured to be coupled to a towing hitch of a towing vehicle; and
a tongue comprising a first arm extending from the towing point to the A-frame coupling of a first one of the longitudinal frame rails, and a second arm extending from the towing point to the A-frame coupling of a second one of the longitudinal frame rails, wherein:
the movable A-frame translates along the A-frame coupling of the longitudinal frame rails between a retracted position and an extended position.
